(19) United States
(12) Patent Application Publication
(10) Pub. No.: US 2026/0205808 A1
(43) Pub. Date: Jul. 16, 2026

(54) RF CHARACTERISTIC USED TO VALIDATE GENUINENESS AND COUNTER A RELAY ATTACK

(71) Applicant: ASSA ABLOY AB, Stockholm (SE)

(72) Inventors: Hans-Juergen Pirch, Gratwein Strassengel (AT); Adam Augustyn, Krzeszowice (PL); Krzysztof Grzegorz Fabjanski, Bielsko-Biala (PL); Andrzej Bohdan Kostyk, Wieliczka (PL)

(21) Appl. No.: 19/135,395

(22) PCT Filed: Jan. 31, 2023
(86) PCT No.: PCT/EP2023/052350

§ 371 Date: Jun. 4, 2025

(51) Int. Cl. H04W 12/06; G07C 9/00; H04W 12/79

(52) U.S. Cl. CPC H04W 12/06; G07C 9/00309; H04W 12/79; G07C 2009/00555

(57) ABSTRACT

A verifier device for an access control system includes physical layer circuitry configured to transmit and receive radio frequency (RF) electrical signals; processing circuitry operatively coupled to the physical layer circuitry and including at least one hardware processor; and a memory. The memory stores instructions that cause the at least one hardware processor to perform operations including: decoding credential information included in a received RF signal; determining an RF fingerprint of the received RF signal, wherein the RF fingerprint includes one or more RF signal parameters determined for the received RF signal; authenticating the credential information and the RF fingerprint; and initiating access to a physical access portal in response to authentication of the credential information and the RF fingerprint.

### TECHNICAL FIELD

Embodiments illustrated and described herein generally relate to automatic identity authentication systems that authenticate users for access to secure resources, and to techniques of preventing security breaches in access control systems.

### BACKGROUND

Access control systems grant physical access to an authorized user through a controlled physical portal such as a secured door. Credential information can be stored on a credential device presented by a user to gain access. A reader device or other verifier device authenticates the credential information to grant access. Unfortunately, attempts to defeat systems that provide secure authentication occur often. It is desirable to develop authentication practices that are difficult to defeat.

### BRIEF DESCRIPTION OF THE DRAWINGS

FIG. 1 is an illustration of an example of an access control system.

FIG. 2 is a flow diagram of an example of an automatic device authentication method.

FIG. 3 is a diagram illustrating an example of the flow of communications between a credential device and a verifier device during an authentication process.

FIG. 4 is an illustration of an example of a relay attack of an authentication process.

FIGS. 5-7 are diagrams illustrating further examples of the flow of communications between a credential device and a verifier device during authentication processes.

FIG. 8 is an illustration of an example of authentication with a verifier device and a credential device in which the credential device is a contact device.

FIG. 9 is a block diagram schematic of portions of an example of a verifier device.

### DETAILED DESCRIPTION

Automatic device authentication can be used to control access to a controlled area. Additionally, remote automatic device authentication may be used in applications such as mobile online shopping or mobile banking. Automatic device authentication involves exchanging sensitive information between devices to prove authorization of the holder of a device, or to prove that information is originating from, or being provided to, an authorized device. For device-based authentication, a credential device presents sensitive credential information to prove identity or authorization to the secured resource, and a verifier device authenticates the credential information. A verifier device can be a reader device located at an access point or an authentication server (e.g., a cloud-based server) of the backend of an authentication system. A credential device can include, but is not limited to, proximity radio frequency identifier (RFID) based cards, access control cards, credit cards, debit cards, passports, identification cards, key fobs, smart keys, near field communication (NFC) enabled devices, mobile phones, personal digital assistants (PDAs), tags, or any other device configurable to emulate a virtual credential.

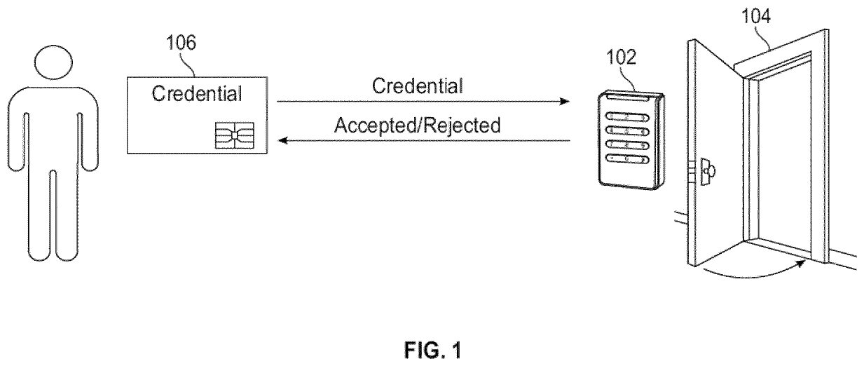

FIG. 1 is an illustration of an example of an access control system that uses automatic device authentication. The system includes a verifier device that is a reader device 102. The reader device 102 includes processing circuitry (e.g., one or more hardware processors) executing instructions included in the software to perform the functions described. The reader device 102 controls access to a secured area through a physical access portal that is a secured door 104. The reader device 102 authorizes access through the portal according to access credential information (e.g., an access credential) stored on a credential device 106. In the example of FIG. 1, the credential device 106 is a smart card. The credential device 106 may send the credential information wirelessly to the reader device 102. The reader device 102 decodes and authenticates the credential information, such as by comparing the credential information to an access control list for example. Based on the results of the authentication process, the reader device 102 grants or denies access to the secured area, such as by controlling or permitting release of an automatic lock on the secured door 104 for example.

Physical access control systems are susceptible to attempts for unauthorized access such as hacking. A relay attack is a type of hacking technique related to man-in-the middle attacks. In a man-in-the-middle attack, communication between the reader device 102 and the credential device 106 may be monitored by the attacking device, and the attacking device listens to messages transferred between the two legitimate devices. The attacking device may be used to mimic the communication with the same or a different reader device 102. If successful, the reader device 102 grants access to the attacking device as if the legitimate credential device 106 was in the present vicinity of the reader device 102 and controlled portal. This may allow access to the holder of the attacking device to the controlled portal.

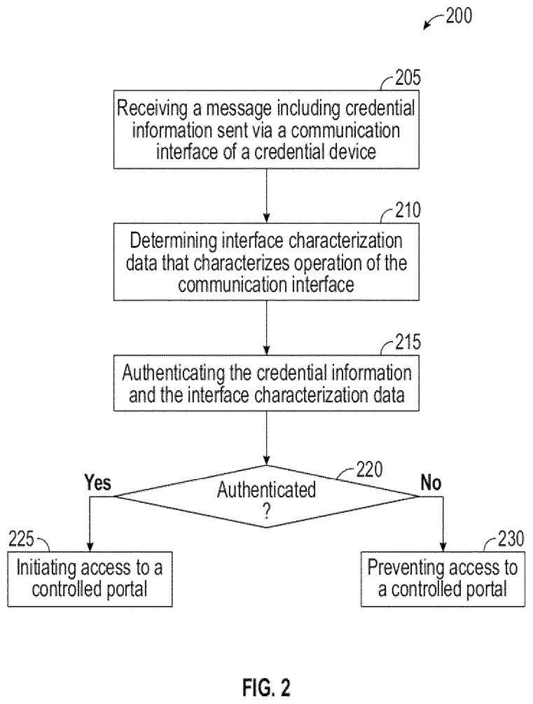

FIG. 2 is a flow diagram of an example of an automatic device authentication method. The method 200 may be performed by a verifier device of an access control system (e.g., the reader device 102 of FIG. 1) and adds another layer of security to the exchange between the verifier device and a credential device.

At block 205, a message from the credential device is received by the verifier device. The message is sent using a communication interface of the credential device. In some examples, the communication interface is a wireless interface, and the verifier device and the credential device communicate using radio frequency (RF) signals. The wireless interface can be a high frequency (HF) RF interface, a low frequency (LF) RF interface, or other type of RF interface.

At block 210, the verifier device determines interface characterization data for the credential device. The characterization data characterizes operation of the communication interface and includes one or more communication parameters determined from the received message. For the wireless interface example, the credential information is sent using one or more RF signals. The characterization data can include an RF fingerprint of the wireless interface. The RF fingerprint includes one or more RF signal parameters determined for the RF signals received from the credential device.

In some examples, the RF signal parameters in the RF fingerprint can include one or both of the minimum field strength of the received RF signal and the center frequency or resonance frequency of the received RF signal as measured by the verifier device. In some examples, the RF fingerprint includes the quality (Q) factor of the received RF signal. The verifier device may measure the Q factor as the ratio of the determined center frequency to the bandwidth of the signal. In some examples, the RF fingerprint includes an electromagnetic disturbance (EMD) parameter of the received RF signal (e.g., the amplitude of noise in RF measurements). In some examples, the credential device is a type of device that returns an RF signal back to the verifier device (e.g., an RFID device). The RF fingerprint can include one or both of the measured load modulation amplitude (LMA) of the returned RF signal, and a measured parameter of the LMA waveform of the returned RF signal.

At block 215, the verifier device authenticates the credential device as genuine by authenticating both the credential information sent by the credential device and the interface characterization data determined for the credential device. To authenticate the credential information, the verifier device may compare the credential information to an access control list stored in memory of the verifier device or stored in a separate device (e.g., a system backend server) with which the verifier device communicates. In some examples, the credential information is stored with other credential data that is protected (e.g., cryptographically) from unauthorized modification.

To authenticate the interface characterization data, the verifier device compares the interface characterization data to specific expected characterization data for the communication interface of the credential device. In some examples, the verifier device compares the determined characterization data to characterization data for the type of device the holder is expected to have. For example, the received credential information may be used by the verifier device to associate a type of credential device with the holder, and the verifier device compares the measured characterization data to specific characterization data for the expected type of credential device. In some examples, all credential devices expected to communicate with the verifier device have the same communication interface type, and the characterization data determined for the communication session is compared to the same expected interface characterization data.

For the wireless interface example, the verifier device compares the determined RF signal parameters of the RF fingerprint to specific RF signal parameters expected from the type of credential device associated with the credential information. The verifier device authenticates the RF fingerprint when the determined RF signal parameters match the expected RF signal parameters.

At block 220, if the information is authenticated, the verifier device initiates access to the controlled portal at block 225. The verifier device may initiate access to the controller portal by opening an automatic lock for the portal, or the verifier device may initiate access to the controller portal by sending a signal to a separate access control device that causes the access control device to grant access to the controlled portal. If the information is not authenticated at block 220, the verifier device prevents access to the controlled portal at block 230.

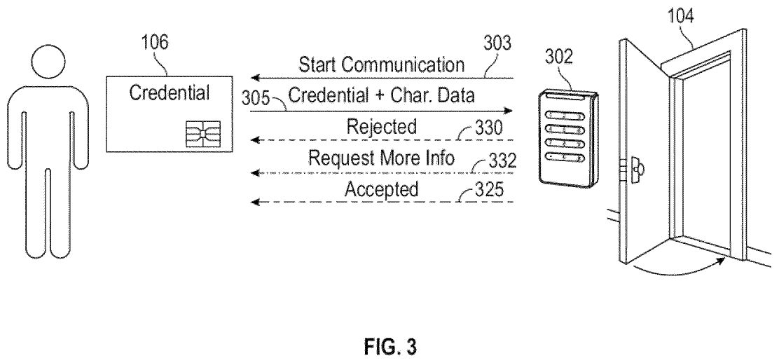

FIG. 3 is an illustration of a credential device 106, a verifier device that is a reader device 302, and an example of the flow of communications between the credential device 106 and the reader device 302 during an authentication process. The reader device 302 starts a communication transaction at 303 that involves the credential device 106 sending a response message 305 that includes credential information. Characterization data for the credential device can be extracted from the communication transaction.

The characterization data may include data specific to the genuine credential device, such as a unique identifier (UID) or chip specific data (e.g., a serial number hard coded on the chip). The characterization data may include an RF fingerprint determined using RF signals sent by the credential device 106 during the communication. The RF fingerprint may include one or more of the minimum field strength of the RF signals, the center frequency or resonance frequency of the RF signals, the Q factor of the RF signals, the LMA waveform of the RF signals, and the EMD of the RF signals.

The RF fingerprint may include timing parameters of the communications by the credential device 106. For example, the credential device 106 may be configured to follow a specific communication protocol (e.g., the ISO 14443 protocol). The RF fingerprint may include timing parameters such as one or more of an expected time to response from a command, an expected start of frame (SOF), and an expected time to end of frame (EOF).

The communication transaction may include an anticollision protocol, and the RF fingerprint can include timing for a response from the credential device 106 according to the anticollision protocol.

In some examples, the reader device 302 and the credential device 106 communicate according to a Near-Field Communication (NFC) Technology Standard protocol. The RF fingerprint may include timing parameters of the protocol such as the Frame Waiting Time (FWT) for a response frame sent by the credential device 106 after the end of a command frame from the reader device 302, or the time it takes the credential device to send a Waiting Time extension Request S(WTX).

If the characterization data matches specific expected characterization data and the credential information is authenticated, the authentication of the credential device 106 is accepted at 325. If the characterization data does not match specific expected characterization data or the credential information is not authenticated, the authentication of the credential device is rejected at 330.

The parameters of the RF fingerprint may vary with manufacturing or may change over time with use of the credential device 106. In some examples, the reader device 302 compares a determined RF parameter to a specified range of values of the RF parameter to determine if the RF fingerprint matches the expected fingerprint. In some examples, the processing circuitry of the reader device 302 computes a probability that the received RF signal originated from an authorized credential device using the determined RF signal parameters. The probability can be computed according to how many RF parameters of the RF fingerprint fall into the specified range of the RF parameters. The reader device 302 may compare the computed probability to a specified probability threshold and authenticate the RF fingerprint when the computed probability is greater than the specified probability threshold (e.g., greater than a 95% probability threshold).

According to some examples, the reader device 302 compares the computed probability to multiple probability thresholds. For instance, the reader device 302 may compare the computed probability to two thresholds; with one threshold being higher than the other threshold. If the computed probability of authenticity of the RF fingerprint is greater than the higher threshold, there is a high probability that the credential device 106 is genuine, and the reader device 302 authenticates the credential device if the credential information is authenticated. If the computed probability of authenticity of the RF fingerprint is less than the lower threshold, there is a low probability that the credential device 106 is genuine, and the reader device 302 rejects authentication of the credential device even if the credential information is authenticated.

If the computed probability of authenticity of the RF fingerprint is less than the higher threshold but greater than the lower threshold, there may be a medium probability that the credential device 106 is genuine. In this case, the reader device 302 may apply one or more additional authentication mechanisms to the communication session with the credential device 106. The reader device 302 initiates access to a physical access portal in response to authentication of the credential information, the RF fingerprint, and the additional authentication criterion.

In some examples, the reader device 302 requests more authorization or credential information at 332 in FIG. 3 if the computed probability falls into the medium probability range. The reader device 302 may send a command to the credential device 106 for additional credential information. For example, if the computed probability that the RF fingerprint is valid is within the medium probability range, the reader device may prompt the holder for biometric information (e.g., a face scan or fingerprint scan) or a personal identification number (PIN). In some examples, the reader device displays a prompt to the holder, and in some examples the reader device sends a command to the credential device requesting the additional credential information.

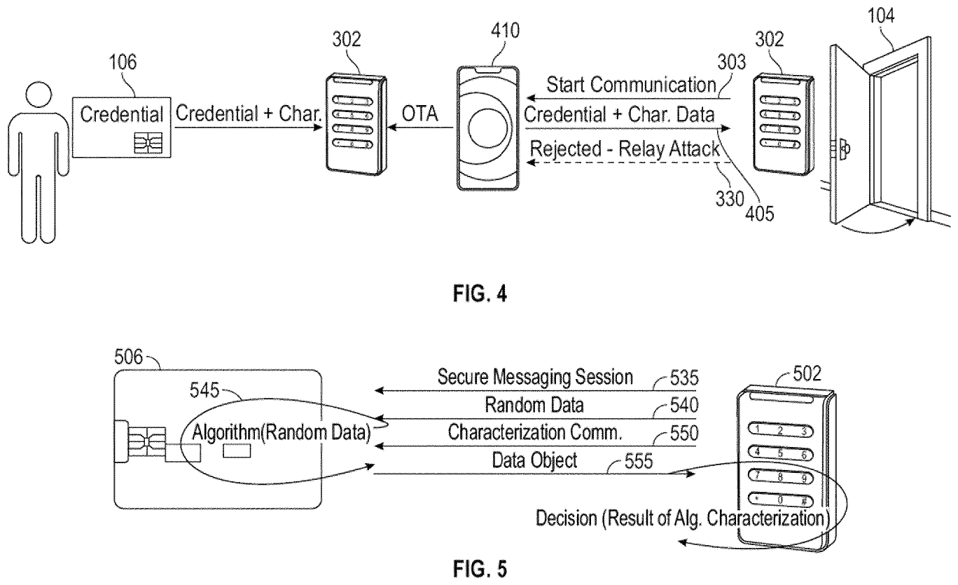

The communication techniques of FIGS. 2 and 3 can be used to prevent relay attacks. FIG. 4 is an illustration of an example of a relay attack. An attacking device 410 may be used to listen (e.g., to over the air (OTA) signaling) to an exchange between a credential device 106 and a reader device 302. Although the reader device 302 in the example of FIG. 4 is used for access control, the reader device 302 may be a proxy device that does not control access to a secured area and can be any reader device that communicates with a credential device 106. The attacking device 410 (e.g., a smartphone) is being used to attempt to mimic the credential device 106 in a communication with the same or different reader device 302 to gain access to the secure portal 104. The attacking device 410 may have obtained the credential information by the listening and attempts to gain access by sending the credential information at 405 to the reader device in a communication transaction.

However, the interface characterization data of the attacking device 410 will be different from the characterization data expected from the characterization data of a genuine credential device 106, and the hacking attempt will be rejected at 330. The processing circuitry of the reader device 302 may initiate an alarm condition or initiate sending an alert signal in response to the failed authentication attempt or after a predetermined number of failed authentication attempts.

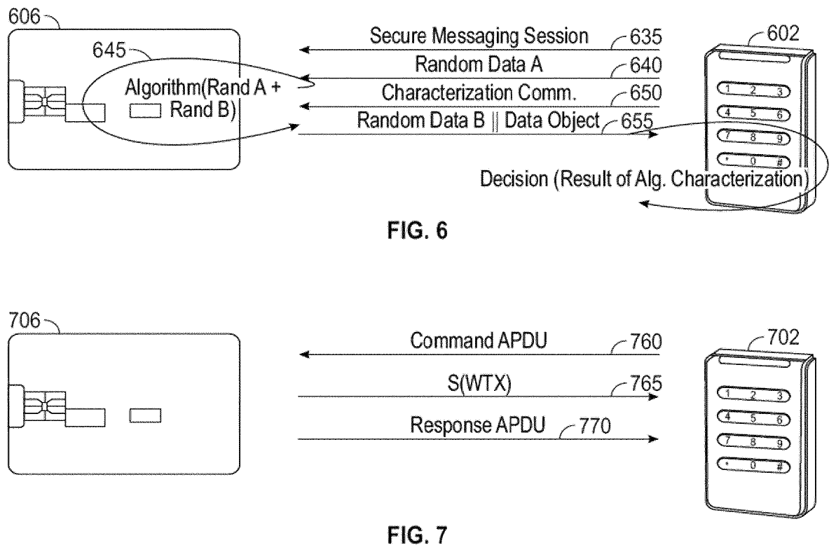

FIG. 5 is an illustration of another example of a flow of communications between a credential device and a verifier device for a device authentication process. The verifier device is again a reader device 502. The reader device 502 and the credential device 506 may communicate according to an operating system (e.g., Seos technology from HID Global) and in some examples the operating system includes an extension that adds additional data objects to the communication using random data. This random data impacts the behavior of the communication interface in a way measurable by the reader device (e.g., a change to the RF fingerprint of the credential device). The reader device 502 authenticates the credential device if the credential device 506 sends the correct credential information and if the credential device 506 communication interface changes behavior in the manner expected.

At 535, secure messaging is used in a communication session with the credential device 506. At 540, random data 540 is sent from the reader device 502. An algorithm 545 is performed by the credential device 506 that uses the random data. Using the random data, the algorithm 545 changes an aspect of the RF fingerprint. To authenticate the credential device 506, a characterization communication 550 is sent by the reader device 502 during the communication session (e.g., a device authentication transaction). At 555 the reader device 502 authenticates the credential device 506 using the standard authentication process. Because an attacking device does not have the algorithm 545, the attacking device would not be able to replicate the change in behavior from a genuine credential device 506, and the reader device 502 would reject the hacking attempt using the interface characterization data.

FIG. 6 is an illustration of another example of a flow of communications between a credential device 606 and the reader device 602 for a device authentication process. As in the example of FIG. 5, random data is added to the communication and used to authenticate the credential device 606, but in the example of FIG. 6 the random data used to modify the RF fingerprint is negotiated by both devices. At 635, a secure messaging session is established with the credential device 606 to send first random data 640 (RANDOM DATA A) to the credential device 606 from the reader device 602. The credential device 606 returns second random data (RANDOM DATA B) as part of the secure messaging session. The credential device 606 performs an algorithm 645 to modify the communication interface (e.g., modify the RF fingerprint).

The reader device 602 uses the concatenation of RANDOM DATA A and RANDOM DATA B to determine what will be the change in communication from the credential device 606. To authenticate the credential device 606, the reader device 602 sends a communication 650 to the credential device 606. The response 655 to the communication 650 sent by the credential device 606 includes the change in communication derived from the random data. The reader device 602 performs the algorithm to determine expected characterization data for the response. The reader device 602 authenticates the credential device 606 using the credential information and the characterization data determined for the response. The reader device 602 would reject a hacking attempt by an attacking device using the credential information without the correct characterization data.

FIG. 7 is an illustration of another example of a flow of communications between a credential device 706 and the reader device 702 for a device authentication process. As in the examples, of FIGS. 5 and 6, random data is sent by the reader device 702 to the credential device 706 using secure messaging. The credential device 706 and reader device 702 may communicate using an NFC Technology Standard protocol, and the random data can be used to impact timing of one or more aspects of the protocol. As an example, the reader device 702 and the credential device 706 may exchange a command frame such as a Command Application Protocol Data Unit (APDU). The Command APDU can include the random data. In some examples, the random data is cryptographically protected (e.g., using a secure messaging communication). A frame waiting time (FWT) defines the maximum time within which a device starts its response frame (response APDU) after the end of a command frame received from the other device. The FWT can be extended by sending a Waiting time Extension Request S(WTX) to extend the FWT. The random data can be used by an algorithm (e.g., algorithm 545 in FIG. 5) to set the value of the time to emit an extra S(WTX) frame from the credential device 706.

In FIG. 7 at 760, the reader device 702 sends a characterization communication that includes a Command APDU to the credential 706. The credential device 706 sends an S(WTX) Frame 765 to the reader device 702 at a time determined using the random data. A Response APDU 770 is returned to the reader device 702 after the duration of a normal processing time. The timing of the S(WTX) frame can be included in the characterization data used by the reader device 702 to authenticate the credential device 706. For example, the reader device 702 may use the timing of the S(WTX) frame, an RF fingerprint, and the credential information to authenticate the credential device 706.

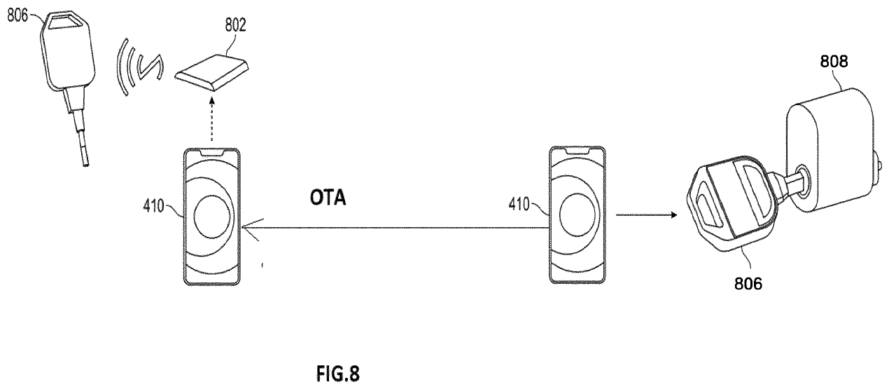

FIG. 8 is an illustration of another example of a relay attack. The authentication is between a smart lock device 808 and a credential device where the credential device has more than one communication interface. In the example of FIG. 8, the credential device is a smart key 806. The smart key 806 includes two interfaces: one interface is a contactless interface (e.g., an RF interface) and the other interface is a contact interface to contact the smart lock device 808 (e.g., a smart lock of the secured door 104 in FIG. 1). Each of the two interfaces may have different interface characterization data and different interface behavior. Typically, it is difficult to get access to the contact interface unnoticed and use it in a relay attack.

In the scenario of FIG. 8, a reader device 802 is using the contactless interface to communicate with the smart key 806. The reader device 802 is being used by an attacking device 410 to perform a relay attack and to authenticate to the smart lock 808 using over the air channel. To communicate to the smart lock 808 another disassembled and hacked smart key 806 is used as a communication interface only. The attacking device 410 is trying to use the disassembled portion of the smart key for the contact interface. However, the smart lock 808 may be expecting a change of the behavior to the contact communication interface determined from random data as in the example of FIG. 5. Because the credential information is communicated over the contactless interface, the expected change will be visible on this interface only. The attacking device 410 does not have the random data or the algorithm used to change the behavior of the contact interface and the hacking attempt will fail.

The techniques described herein can be used in systems, methods, and devices that add interface characterization data to device-based authentication for automatic secure access. The analysis of interface characterization data like an RF fingerprint can be used to differentiate credential devices and to detect that the credential information was copied to a different credential device. It can also be used to detect a relay attack in which credential information issued for a credential device in one technology (e.g., a Java Card or native technology) is being emulated with an attacking device using another technology (e.g., a smartphone with NFC capability).

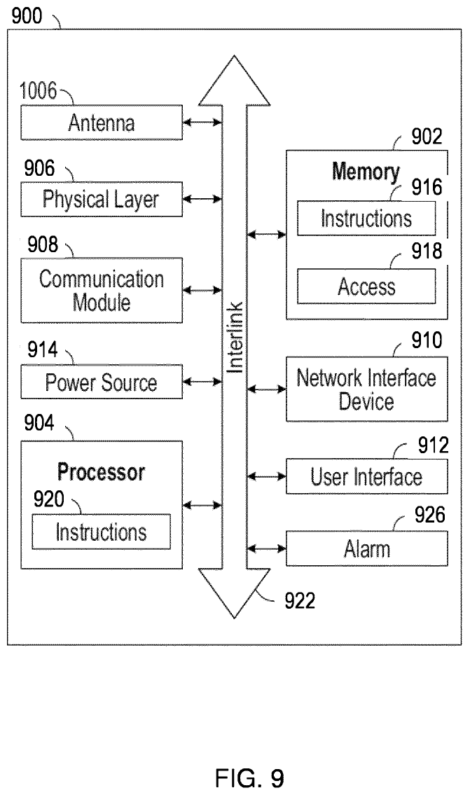

FIG. 9 is a block diagram schematic of various example components of a device 900 for supporting the device architectures described and illustrated herein. The device 900 may be a verifier device used to verify credential information of authority, status, rights, and/or entitlement to the holder of a credential device presenting the credential information. A credential device may also include some, or all of the components described with respect to device 900.

With reference specifically to FIG. 9, additional examples of a device 900 for supporting the device architecture described and illustrated herein may generally include one or more of a memory 902, processing circuitry such as processor 904, one or more antennas 906, a communication port or communication module 908, a network interface device 910, a user interface 912, and a power source 914 or power supply.

Memory 902 can be used in connection with the execution of application programming or instructions by processing circuitry, and for the temporary or long-term storage of program instructions or instruction sets 916, as well as any data, data structures, and/or computer-executable instructions needed or desired to support the above-described device architecture, such as an access control list or other access information 918. For example, memory 902 can contain executable instructions 916 that are used by a processor 904 of the processing circuitry to run other components of device 900, to perform operations of a verifier device to transfer credential information and to determine interface characterization data of a credential device, and/or to perform any of the functions or operations described herein, such as the method of FIG. 2 for example. Memory 902 can comprise a computer readable medium that can be any medium that can contain, store, communicate, or transport data, program code, or instructions for use by or in connection with device 900. The computer readable medium can be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), Dynamic RAM (DRAM), any solid-state storage device, in general, a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

The processing circuitry of the device 900 is configured (e.g., by firmware) to perform the functions of verifier devices described herein, such as the functions of the method of FIG. 2 for example. In some examples, the device is a credential device, and the processing circuitry is configured to perform the functions of the credential device, such as by performing algorithms based on random data for example. The processing circuitry can correspond to one or more computer processing devices or resources. For instance, processor 904 can be provided as silicon, as a Field Programmable Gate Array (FPGA), an Application-Specific Integrated Circuit (ASIC), any other type of Integrated Circuit (IC) chip, a collection of IC chips, or the like. As a more specific example, processor 904 can be provided as a microprocessor, Central Processing Unit (CPU), or plurality of microprocessors or CPUs that are configured to execute instructions sets stored in an internal memory 920 and/or memory 902.

Antenna 906 can correspond to one or multiple antennas and can be configured to provide for wireless communications between device 900 and another device. Antenna(s) 906 can be operatively coupled to physical layer circuitry comprising one or more physical (PHY) layers 924 to operate using one or more wireless communication protocols and operating frequencies including, but not limited to, the IEEE 802.15.1, Bluetooth®, Bluetooth® Low Energy (BLE), Near Field Communications (NFC), ZigBee, Global System for Mobile (GSM), Code Division Multiple Access (CDMA), Wi-Fi, RF, ultra-wide band (UWB), and the like.

Device 900 may additionally include a communication module 908 and/or network interface device 910. Communication module 908 can be configured to communicate according to any suitable communications protocol with one or more different systems or devices either remote or local to device 900. Network interface device 910 includes hardware to facilitate communications with other devices over a communication network utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, wireless data networks (e.g., IEEE 802.11 family of standards known as Wi-Fi, IEEE 802.16 family of standards known as WiMax), IEEE 802.15.4 family of standards, and peer-to-peer (P2P) networks, among others. In some examples, network interface device 910 can include an Ethernet port or other physical jack, a Wi-Fi card, a Network Interface Card (NIC), a cellular interface (e.g., antenna, filters, and associated circuitry), or the like. In some examples, network interface device 910 can include a plurality of antennas to wirelessly communicate using at least one of single-input multiple-output (SIMO), multiple-input multiple-output (MIMO), or multiple-input single-output (MISO) techniques. In some example embodiments, one or more of the antenna 906, communication module 908, and/or network interface device 910 or subcomponents thereof, may be integrated as a single module or device, function or operate as if they were a single module or device, or may comprise of elements that are shared between them.

User interface 912 can include one or more input devices and/or display devices. Examples of suitable user input devices that can be included in user interface 912 include, without limitation, one or more buttons, a keyboard, a mouse, a touch-sensitive surface, a stylus, a camera, a microphone, etc. Examples of suitable user output devices that can be included in user interface 912 include, without limitation, one or more LEDs, an LCD panel, a display screen, a touchscreen, one or more lights, a speaker, etc. It should be appreciated that user interface 912 can also include a combined user input and user output device, such as a touch-sensitive display or the like.

Alarm circuit 926 may provide an audio signal to a speaker or may activate a light or present an alarm condition using a display device. Power source 914 can be any suitable internal power source, such as a battery, capacitive power source or similar type of charge-storage device, etc., and/or can include one or more power conversion circuits suitable to convert external power into suitable power (e.g., conversion of externally-supplied AC power into DC power) for components of the device 900.

Device 900 can also include one or more interlinks or buses 922 operable to transmit communications between the various hardware components of the device. A system bus 922 can be any of several types of commercially available bus structures or bus architectures.

### ADDITIONAL DISCLOSURE AND EXAMPLES

Example 1 includes subject matter (such as a verifier device for an access control system) including physical layer circuitry configured to transmit and receive electrical radio frequency (RF) signals; processing circuitry operatively coupled to the physical layer circuitry and including at least one hardware processor; and a memory. The memory is to store instructions that when performed by the at least one hardware processor cause the processing circuitry to perform operations including decoding credential information included in a received RF signal; determining an RF fingerprint of the received RF signal, wherein the RF fingerprint includes one or more RF signal parameters determined for the received RF signal; authenticating the credential information and the RF fingerprint; and initiating access to a physical access portal in response to authentication of the credential information and the RF fingerprint.

In Example 2, the subject matter of Example 1 optionally includes instructions to cause the processing circuitry to authenticate the RF fingerprint by comparing the one or more determined RF signal parameters to one or more specified RF signal parameters associated with a type of credential device associated with the credential information; and authenticating the RF fingerprint when the one or more determined RF signal parameters match the one or more specified RF signal parameters.

In Example 3, the subject matter of one or both of Examples 1 and 2 optionally includes instructions to cause the processing circuitry to perform operations including computing a probability that the received RF signal originated from an authorized credential device using the determined RF signal parameters; and authenticating the RF fingerprint when the computed probability is greater than a specified first probability threshold.

In Example 4, the subject matter of Example 3 optionally includes the instructions to cause the processing circuitry to perform operations including applying an additional authentication mechanism when the computed probability is less than the first probability threshold and is greater than a specified second probability threshold; initiating access to a physical access portal in response to authentication of the credential information, the RF fingerprint, and the additional authentication mechanism; and preventing access to the physical access portal when the computed probability is less than the second probability threshold.

In Example 5, the subject matter of Example 4 optionally includes instructions to cause the processing circuitry to perform operations including requesting one or both of biometric information and a personal identification number (PIN).

In Example 6, the subject matter of one or any combination of Examples 3-5 optionally includes instructions to cause the processing circuitry to perform operations including initiating sending a command for additional credential information when the computed probability is less than the first probability threshold and is greater than a specified second probability threshold; decoding the additional credential information received in a response to the command; initiating access to a physical access portal in response to authentication of the credential information, the RF fingerprint, and the additional credential information; and preventing access to the physical access portal when the computed probability is less than the second probability threshold.

In Example 7, the subject matter of one or any combination of Examples 1-6 optionally includes instructions to cause the processing circuitry to perform operations including determining a type of communication interface that sent the received RF signal using the RF fingerprint; and preventing access to the physical access portal when the determined type of communication interface is not a type of communication interface associated with the credential information.

In Example 8, the subject matter of one or any combination of Examples 1-7 optionally includes instructions to cause the processing circuitry to perform operations including determining the RF fingerprint by determining one or more of a minimum field strength of the received RF signal, a load modulation amplitude of the received RF signal, and a load modulation amplitude waveform parameter of the received RF signal.

In Example 9, the subject matter of one or any combination of Examples 1-8 optionally includes instructions to cause the processing circuitry to perform operations including determining the RF fingerprint by determining one or more of a center frequency of the received RF signal, a quality factor of the received RF signal, and an electromagnetic disturbance (EMD) parameter of the received RF signal.

Example 10 includes subject matter (such as a method of operating an authorization verifier device) or can optionally be combined with one or any combination of Examples 1-9 to include such subject matter, including receiving credential information included in a received RF signal; determining an RF fingerprint of the received RF signal, wherein the RF fingerprint includes one or more RF signal parameters determined for the received RF signal; authenticating the credential information and the RF fingerprint; and initiating access to a physical access portal in response to authentication of the credential information and the RF fingerprint.

In Example 11, the subject matter of Example 10 optionally includes comparing the one or more determined RF signal parameters to one or more specified RF signal parameters associated with a type of credential device associated with the credential information; and authenticating the RF fingerprint when the one or more determined RF signal parameters match the one or more specified RF signal parameters.

In Example 12, the subject matter of one or both of Examples 10 and 11 optionally includes computing a probability that the received RF signal originated from an authorized credential device using the determined RF signal parameters, and authenticating the RF fingerprint when the computed probability is greater than a specified first probability threshold.

In Example 13, the subject matter of Example 12 optionally includes applying an additional authentication mechanism to a communication session that includes the received RF signal when the computed probability is less than the first probability threshold and is greater than a specified second probability threshold; initiating access to the physical access portal in response to authentication of the credential information, the RF fingerprint, and the additional authentication mechanism; and preventing access to the physical access portal when the computed probability is less than the second probability threshold.

In Example 14, the subject matter of Example 13 optionally includes authenticating one or both of biometric information and a personal identification number (PIN).

In Example 15, the subject matter of one or any combination of Examples 12-14 optionally includes initiating sending a command for additional credential information when the computed probability is less than the first probability threshold and is greater than a specified second probability threshold; receiving the additional credential information in a response message received in response to the command; initiating access to a physical access portal in response to authentication of the credential information, the RF fingerprint, and the additional credential information; and preventing access to the physical access portal when the computed probability is less than the second probability threshold.

In Example 16, the subject matter of one or any combination of Examples 10-15 optionally includes determining one or more of a minimum field strength of the received RF signal, a load modulation amplitude of the received RF signal, and a load modulation amplitude waveform parameter of the received RF signal.

In Example 17, the subject matter of one or any combination of Examples 10-16 optionally includes determining the RF fingerprint by determining one or more of a center frequency of the received RF signal, a quality factor of the received RF signal, and an electromagnetic disturbance (EMD) parameter of the received RF signal.

Example 18 includes subject matter (such as a verifier device for an access control system) or can optionally be combined with one or any combination of Examples 1-17 to include such subject matter, including physical layer circuitry configured to transmit and receive radio frequency (RF) electrical signals; processing circuitry operatively coupled to the physical layer circuitry and including at least one hardware processor; and a memory. The memory stores instructions that cause the at least one hardware processor to perform operations including: receiving, by the verifier device, a message including credential information sent via a communication interface of a credential device; determining interface characterization data characterizing operation of the communication interface of the credential device, wherein the characterization data includes one or more communication parameters determined using the received message; authenticating the credential information and the interface characterization data; and initiating access to a physical access portal in response to authentication of the credential information and the interface characterization data.

In Example 19, the subject matter of Example 18 optionally includes interface characterization data including an RF fingerprint that includes one or more of a minimum field strength of the received RF signal, a load modulation amplitude of the received RF signal, a load modulation amplitude waveform parameter of the received RF signal, a center frequency of the received RF signal, a quality factor of the received RF signal, and an electromagnetic disturbance (EMD) parameter of the received RF signal.

In Example 20, the subject matter of one or both of Examples 18 and 19 optionally includes interface characterization data including an RF fingerprint that includes communication timing parameters identifying a specific communication protocol being used by the credential device.

These non-limiting Examples can be combined in any permutation or combination. The above detailed description includes references to the accompanying drawings, which form a part of the detailed description. The drawings show, by way of illustration, specific embodiments in which the invention can be practiced. The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. In the above Detailed Description, various features may be grouped together to streamline the disclosure. This should not be interpreted as intending that an unclaimed disclosed feature is essential to any claim. Rather, the subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope should be determined with reference to the appended claims, along with the full scope of equivalents to which such claims are entitled.

1. A verifier device for an access control system, the device comprising:
physical layer circuitry configured to transmit and receive electrical radio frequency (RF) signals;
processing circuitry operatively coupled to the physical layer circuitry and including at least one hardware processor; and
a memory storing instructions that when performed by the at least one hardware processor cause the processing circuitry to perform operations including:
decoding credential information included in a received RF signal;
determining an RF fingerprint of the received RF signal, wherein the RF fingerprint includes one or more RF signal parameters determined for the received RF signal;
authenticating the credential information and the RF fingerprint; and
initiating access to a physical access portal in response to authentication of the credential information and the RF fingerprint.

2. The device of claim 1, wherein the instructions cause the processing circuitry to authenticate the RF fingerprint by:
comparing the one or more determined RF signal parameters to one or more specified RF signal parameters associated with a type of credential device associated with the credential information; and
authenticating the RF fingerprint when the one or more determined RF signal parameters match the one or more specified RF signal parameters.

3. The device of claim 1, wherein the instructions cause the processing circuitry to perform operations including:
computing a probability that the received RF signal originated from an authorized credential device using the determined RF signal parameters; and
authenticating the RF fingerprint when the computed probability is greater than a specified first probability threshold.

4. The device of claim 3, wherein the instructions cause the processing circuitry to perform operations including:
applying an additional authentication mechanism when the computed probability is less than the first probability threshold and is greater than a specified second probability threshold;
initiating access to a physical access portal in response to authentication of the credential information, the RF fingerprint, and the additional authentication mechanism; and
preventing access to the physical access portal when the computed probability is less than the second probability threshold.

5. The device of claim 4, wherein the instructions cause the processing circuitry to perform operations including to apply an additional authentication mechanism that includes the verifier device requesting one or both of biometric information and a personal identification number (PIN).

6. The device of claim 3, wherein the instructions cause the processing circuitry to perform operations including:
initiating sending a command for additional credential information when the computed probability is less than the first probability threshold and is greater than a specified second probability threshold;
decoding the additional credential information received in a response to the command;
initiating access to a physical access portal in response to authentication of the credential information, the RF fingerprint, and the additional credential information; and
preventing access to the physical access portal when the computed probability is less than the second probability threshold.

7. The device of claim 1, wherein the instructions cause the processing circuitry to perform operations including:
determining a type of communication interface that sent the received RF signal using the RF fingerprint; and
preventing access to the physical access portal when the determined type of communication interface is not a type of communication interface associated with the credential information.

8. The device of claim 1, wherein the instructions cause the processing circuitry to perform operations including determining the RF fingerprint by determining one or more of a minimum field strength of the received RF signal, a load modulation amplitude of the received RF signal, and a load modulation amplitude waveform parameter of the received RF signal.

9. The device of claim 1, wherein the instructions cause the processing circuitry to perform operations including determining the RF fingerprint by determining one or more of a center frequency of the received RF signal, a quality factor of the received RF signal, and an electromagnetic disturbance (EMD) parameter of the received RF signal.

10. A method of operating an authorization verifier device, the method comprising:
receiving credential information included in a received RF signal;
determining an RF fingerprint of the received RF signal, wherein the RF fingerprint includes one or more RF signal parameters determined for the received RF signal;
authenticating the credential information and the RF fingerprint; and
initiating access to a physical access portal in response to authentication of the credential information and the RF fingerprint.

11. The method of claim 10, wherein the authenticating the RF fingerprint includes:
comparing the one or more determined RF signal parameters to one or more specified RF signal parameters associated with a type of credential device associated with the credential information; and
authenticating the RF fingerprint when the one or more determined RF signal parameters match the one or more specified RF signal parameters.

12. The method of claim 10, wherein the authenticating the RF fingerprint includes:
computing a probability that the received RF signal originated from an authorized credential device using the determined RF signal parameters; and
authenticating the RF fingerprint when the computed probability is greater than a specified first probability threshold.

13. The method of claim 12, wherein the authenticating the RF fingerprint further includes:
applying an additional authentication mechanism to a communication session that includes the received RF signal when the computed probability is less than the first probability threshold and is greater than a specified second probability threshold;
initiating access to the physical access portal in response to authentication of the credential information, the RF fingerprint, and the additional authentication mechanism; and
preventing access to the physical access portal when the computed probability is less than the second probability threshold.

14. The method of claim 13, wherein the applying the additional authentication mechanism includes authenticating one or both of biometric information and a personal identification number (PIN).

15. The method of claim 12, wherein the authenticating the RF fingerprint further includes:
initiating sending a command for additional credential information when the computed probability is less than the first probability threshold and is greater than a specified second probability threshold;
receiving the additional credential information in a response message received in response to the command;
initiating access to a physical access portal in response to authentication of the credential information, the RF fingerprint, and the additional credential information; and
preventing access to the physical access portal when the computed probability is less than the second probability threshold.

16. The method of claim 10, wherein the determining the RF fingerprint includes determining one or more of a minimum field strength of the received RF signal, a load modulation amplitude of the received RF signal, and a load modulation amplitude waveform parameter of the received RF signal.

17. The method of claim 10, wherein the determining the RF fingerprint includes determining the RF fingerprint by determining one or more of a center frequency of the received RF signal, a quality factor of the received RF signal, and an electromagnetic disturbance (EMD) parameter of the received RF signal.

18. A verifier device for an access control system, the device comprising:
physical layer circuitry configured to transmit and receive radio frequency (RF) electrical signals;
processing circuitry operatively coupled to the physical layer circuitry and including at least one hardware processor; and
a memory storing instructions that cause the at least one hardware processor to perform operations including:
receiving, by the verifier device, a message including credential information sent via a communication interface of a credential device;
determining interface characterization data characterizing operation of the communication interface of the credential device, wherein the characterization data includes one or more communication parameters determined using the received message;
authenticating the credential information and the interface characterization data; and
initiating access to a physical access portal in response to authentication of the credential information and the interface characterization data.

19. The device of claim 18, wherein the interface characterization data includes an RF fingerprint that includes one or more of a minimum field strength of the received RF signal, a load modulation amplitude of the received RF signal, a load modulation amplitude waveform parameter of the received RF signal, a center frequency of the received RF signal, a quality factor of the received RF signal, and an electromagnetic disturbance (EMD) parameter of the received RF signal.

20. The device of claim 18, wherein the interface characterization data includes an RF fingerprint that includes communication timing parameters identifying a specific communication protocol being used by the credential device.
